(19) United States
(12) Patent Application Publication
(10) Pub. No.: US 2016/0149708 A1
(43) Pub. Date: May 26, 2016

(54) ELECTRONIC SIGNATURE SYSTEM

(71) Applicant: KONINKLIJKE PHILIPS N.V., Eindhoven (NL)

(72) Inventors: OSCAR GARCIA MORCHON, AACHEN (DE); RONALD RIETMAN, EINDHOVEN (NL); LUDOVICUS MARINUS GERARDUS MARIA TOLHUIZEN, WAALRE (NL)

(73) Assignee: KONINKLIJKE PHILIPS N.V., Eindhoven (NL)

(21) Appl. No.: 14/903,312

(22) PCT Filed: Jul. 7, 2014
(86) PCT No.: PCT/EP2014/064467

§ 371 Date: Jan. 7, 2016

Related U.S. Application Data
(60) Provisional application No. 61/845,391, filed on Jul. 12, 2013.

(30) Foreign Application Priority Data
Dec. 17, 2013 (EP) 13197623.5

(51) Int. Cl. H04L 9/32; H04L 9/30

(52) U.S. Cl. CPC H04L 9/3247; H04L 9/3093

(57) ABSTRACT

Electronic signature system comprising an electronic key generation device (100) for generating a digital signing-key for digitally signing digital data and a corresponding verification-key for digitally verifying said digitally signed data, an electronic signature generation device (200) for generating a digital signature for digital data using a digital signing-key obtained from an electronic key generation device, and an electronic signature verification device (300) for verifying a digital signature generated by an electronic signature generation device. The verifier has access to a commitment integer and corresponding polynomial derived from private keying material, enabling verification of signature polynomials derived the same private keying material.

### FIELD OF THE INVENTION

The invention relates to a signature system comprising the electronic signature generation device and the electronic signature verification device.

### BACKGROUND

A digital signature is a mathematical scheme for demonstrating the authenticity of a digital data, say a message or a document. A valid digital signature should make a recipient trust that the data was created by a known sender (authentication), such that the sender cannot deny having sent the message (non-repudiation) and that the message was not altered in transit (integrity). Digital signatures are used for software distribution, financial transactions, and in other cases where it is important to detect forgery or tampering.

Digital signatures are a type of asymmetric cryptography. Digitally signed messages may be represented as a bit-string: examples include electronic mail, contracts, or a message sent via some other cryptographic protocol.

Known digital signature systems include the RSA system, introduced in 1977, by Ronald Rivest, Adi Shamir, and Len Adleman. The system requires modular exponentiation. Accordingly, computations are needed using large numbers, typically 1024 bits or even larger.

Also polynomials have been used to define a signature system, for example, the Elliptic Curve Digital Signature Algorithm (ECDSA), which is a variant of the Digital Signature Algorithm (DSA) which uses elliptic curve cryptography. ECDSA requires one to calculate a multiple of a rational point on an elliptic curve. This computation is complicated.

There is a need for a signature scheme that is easier to implement and requires little resources either in storage or in computation.

### SUMMARY OF THE INVENTION

It would be advantageous to have an improved electronic signature system.

A signature system is provided comprising an electronic signature generation device and an electronic signature verification device. An embodiment of the system comprises an electronic key generation device.

The electronic key generation device is configured for generating a digital signing-key for digitally signing digital data and a corresponding verification-key for digitally verifying said digitally signed data. The key generation device comprises a key material obtainer, a public key generator and a key manager.

The key material obtainer obtains the keying material needed to derive the public key and for signing data. The key material obtainer is configured for obtaining in electronic form a first private set of bivariate polynomials and a second private set of reduction integers, with each bivariate polynomial in the first set there is associated a reduction integer of the second set.

The public key generator derives information from the obtained keying material which allows a party to verify a signature, but not create a signature. The public key generator is configured to obtain a third public set of commitment integers and to compute a corresponding univariate public polynomial for each specific integer in the third public set. A univariate public polynomial being computed from the specific integer and the first and second private sets by: obtaining a further set of univariate polynomials by: for each particular polynomial of the first private set, substituting the specific integer into said particular polynomial and reducing modulo the reduction integer associated with said particular polynomial, and summing the univariate polynomials of the further set of univariate polynomial.

Finally, the key manager enables signing and verifying parties. It is configured to make the first private set of bivariate polynomials and the second private set of reduction integers, available to an electronic signature generation device for use as the signing-key to digitally sign digital data, and to make at least part of at least one of the public polynomials computed by the public key generator from the third public set of commitment integers available to an electronic signature verification device for use as the verification-key to digitally verify digital data signed by the signature generation device.

Summing polynomials that have been partially evaluated over different rings is a non-linear operation. It is hard to recover the original material after the summing took place. Nevertheless, it is possible to verify relationships that hold over the polynomials, as discussed below. In particular, having access to a commitment integer and the corresponding univariate polynomial a party can verify if signature polynomials produced by a signer are associated with the same private key material.

The signature system requires only basic polynomial evaluation, and not e.g., the multiplication of points on curves defined by the polynomials. The system is an efficient signature system based on this new hard problem.

In an embodiment, the electronic key generation device is configured to further obtain a public global reduction integer larger than each of the reduction integers in the second private set, the key manager is configured to make the public global reduction integer available to the signature verification device. Preferably, the key management device is configured to make the public global reduction integer available to the electronic signature generation device and the public key generator is configured to reduce the result of summing the further set of univariate polynomials modulo the public global reduction integer. This reduces the size of signatures.

In an embodiment, the public key generator is configured to reduce the result of the summing of the further set of univariate polynomials modulo the public global reduction integer. This step reduces the size of the coefficients. This step also removes information regarding the absolute size of the summing.

After the summing of the polynomials there are different options to proceed. For example, one may continue with the result of the summing directly, possibly after bringing it into a canonical form, say an array of coefficients which is, say ordered by degree. For example, one may reduce the result of the summing modulo a number, e.g., a public global reduction integer. One may also ignore, e.g. remove, parts of the polynomial. In the latter case the summing result may first be reduced module the public global reduction integer after which parts of the coefficients are removed. These options increasingly reduce the size of the verification key. For example, in an embodiment, bits between the most and least significant bits of a coefficient of the polynomial(s) are ignored (we refer to a string of bits as middle bits, if the string neither includes the most significant bit nor the last significant bit). In an embodiment, the size of said removed part decreases with the degree of the monomial corresponding to the coefficient. For example, one may keep the b least significant bits and the ib most significant bits of a coefficient, wherein i represents the degree of monomial corresponding to the coefficient.

In an embodiment, the summing of the univariate polynomials ignores a predetermined part of the coefficients of the further set of univariate polynomials. Preferably, the summing is reduced modulo the public global reduction integer and then the predetermined parts of the coefficients are removed.

Indeed, in an embodiment, the key generation device is configured to reduce the bit-size of the at least one of the public polynomials by removing at least part of the bits of at least one coefficient before making the at least part of at least one of the public polynomials available to the electronic signature verification device. For example, a particular coefficient of a particular one of the public polynomials is selected; for this coefficient a smaller bit-size is obtained by removing, e.g. ignoring, part thereof. The part is preferably, a middle part, as further explained in embodiments below. A larger size reduction is obtained by removing bits from more than one coefficient and/or for more than one polynomial. In an embodiment, the size of said removed part decreases with the degree of the monomial corresponding to the coefficient. Removing part of a coefficient may be done by a suitable part of the key generation device, say the public key generator or the key manager, or the like. After reduction a coefficient retains at least part of its least significant bits.

The key manager may supply other information together with key information, for example the number of hashes which the signer uses (see below). The verifier may use this information to verify that he received the correct number of hashes.

In an embodiment, the bivariate polynomials are bivariate monomials.

The electronic signature generation device is configured for generating a digital signature for digital data using a digital signing-key obtained from an electronic key generation device. The signature generation device comprises a hashing device, and a signature generator.

The hashing device is configured to determine a fourth set of hashes by applying multiple different hash functions to the digital data. The hashes are linked to the digital data. Preferably, a cryptographic hash is used, say sha-2, sha-256, and the like. Different hash functions may be obtained in various ways. In an embodiment, the different hash functions are derived from one hash function (h), by combining the digital data with an identifier that identifies the hash function, and using this combination as input to the hash function (h). The identifier may be a number, say a series number. The different hash functions may also be derived as a hash chain. In that embodiment, the first hash is obtained by applying a hash function to the digital data. The next hash is obtained by hashing the resulting hash of the previous hash.

The signature generator is configured to compute univariate signature polynomials for each specific hash in the fourth set. A univariate signature polynomial corresponding to the specific hash is computed from the specific hash and the first and second private sets by: obtaining a further set of univariate polynomials by: for each particular polynomial of the first private set, substituting the specific hash into said particular polynomial and reducing modulo the reduction integer associated with said particular polynomial, and summing the further set of univariate polynomials, wherein said generated digital signature comprises a fifth set of signature polynomial comprising at least part of each signature polynomial generated by the signature key generator for the fourth set of hashes.

As with the public polynomials obtained from commitment integers, also after the summing of the polynomials in the signature generation device there are different options to proceed. For example, one may continue with the result of the summing directly, possibly after bringing it into a canonical form, say an array of coefficients which is, say ordered by degree. For example, one may reduce the result of the summing modulo a number, e.g., a public global reduction integer. One may also ignore, e.g. remove, parts of the polynomial. In the latter case the summing result may first be reduced module the public global reduction integer after which parts of the coefficients are removed. These options increasingly reduce the size of the verification key. For example, in an embodiment, part of the middle of a coefficient of the polynomial(s) are ignored. In an embodiment, the part of the coefficient of the polynomials that is ignored increases as the degree of the monomial decreases.

In an embodiment, the summing of the univariate polynomials ignores a predetermined part of the coefficients of the further set of univariate polynomials. Preferably, the summing is reduced modulo the public global reduction integer and then the predetermined parts of the coefficients are removed. In an embodiment, the removal step is not used.

Indeed, in an embodiment, the electronic signature generation device has access to a public global reduction integer generated by the electronic key generation device. The signature generator is configured to reduce the result of the summing of the further set of univariate polynomials modulo the public global reduction integer. The electronic signature generation device is configured to reduce the bit-size of at least one of the signature polynomials by removing at least part of the bits of at least one coefficient.

For example, a particular coefficient of a particular one of the signature polynomials is selected; for this coefficient a smaller bit-size is obtained by removing, e.g. ignoring, part thereof. The part is preferably, a middle significant part, as further explained in embodiments below. A larger size reduction is obtained by removing bits from more than one coefficient and/or for more than one polynomial. In an embodiment, the size of said removed part decreases with the degree of the monomial corresponding to the coefficient. Removing part of a coefficient may be done by a suitable part of the key generation device, say the signature generator, or the like.

Generating the univariate signature polynomials and/or the univariate public polynomial may comprise further steps, e.g., a reduction step following the summing. After the reduction step, yet a further step may follow, e.g., partial removal of coefficients. In an embodiment, the partial removal of coefficients comprises the partial removal of one or more middle significant bits of at least one of the coefficients of a polynomial. For example, one may keep the b least significant bits and the ib most significant bits of a coefficient, wherein i represents the degree of monomial corresponding to the coefficient.

The electronic signature verification device is configured for verifying a digital signature generated by an electronic signature generation device. The signature verification device has access to at least one commitment integer and at least one corresponding univariate public polynomial generated by an electronic key generation device. The digital signature comprises at least one univariate signature polynomial. The signature verification device comprises a hashing device and a signature verifier.

The hashing device is configured to determine a hash corresponding to a signature polynomial by applying a hash function to the digital data. If the digital data has not been altered after signing, then the hashing device should obtain the same hashes as the signing device.

The signature verifier is configured to verify a match between the at least one univariate signature polynomial and the at least one univariate public polynomial, by for a specific univariate signature polynomial of the at least one univariate signature polynomial and a specific univariate public polynomial of the at least one univariate public polynomial, substituting the hash corresponding to the specific signature polynomial in the specific public polynomial, thus obtaining a first substitution result, substituting the commitment integer corresponding to the specific public polynomial in the specific signature polynomial obtaining a second substitution result, verifying that the first substitution result matches the second substitution result, wherein the signature verification device requires a match to verify the digital signature.

In this way it is verified that the signature polynomial and the public polynomials originate from the same keying material, e.g., as obtained by the keying material obtainer.

As pointed out above, both the key generation device and the signature generation device may reduce the size of the verification key and the signature polynomials respectively, by removing parts of the coefficient that have little or no influence on the verification result. The verification device such size reduction have only the result that bounds for the matching step may change somewhat, however the computations that need to be performed do not change.

In an embodiment, the digital signature comprises at least two univariate signature polynomials, and the signature verifier is configured perform a further test on the signatures.

The signature verifier is configured to verify a consistency between the at least two univariate signature polynomials, by for a first and second specific univariate signature polynomial of the at least two univariate signature polynomials: substitute the hash value corresponding to the first specific signature polynomial in the second specific signature polynomial obtaining a first substitution result, substitute the hash value corresponding to the second specific signature polynomial in the first specific signature polynomial obtaining a second substitution result, verifying that the first consistency result matches the second consistency result, wherein the signature verification device requires a match to verify the digital signature.

This test verifies if the signatures are consistent and come from the same private keying material. This test does not on its own verify the link with the digital data, but importantly reduces the opportunity of an attacker to provide fake signatures. A fake signature passing the first test given above, may well fail the consistency test.

To perform both tests, at least two different univariate signature polynomials are needed, and thus two hashes. When at least two univariate signature polynomials and at least one commitment integer and corresponding public polynomial is available, two signature verifications on the public polynomial are possible, and one verification on the signature polynomials.

As the polynomials result from adding over different rings, two substitution results need not be exactly equal to have a match. Nevertheless, the two substitution results are close to each other. Given one substitution result there are only a limited number of possibilities for the second substitution result. The exact number of possibilities depends on how the parameters, are chosen; in particular the private set of reduction integers qⱼ and the public global reduction integer N. It also depends on how many bits are kept of the coefficients.

The following test may be used to see if two substitution results match. The signature verifier may be configured to verify a match by verifying existence of a multiplier such that a predetermined number of least significant bits of the first substitution result plus the multiplier times the public global reduction integer equals the predetermined number of least significant bits of the second substitution result. The signature verifier could also be configured to verify a match by verifying existence of a multiplier such that a predetermined number of least significant bits of the second substitution result plus the multiplier times the public global reduction integer equals the predetermined number of least significant bits of the first substitution result.

The key generation, signature generation and signature verification devices are electronic devices, in particular they may be mobile electronic devices, e.g., a mobile phone, set-top box, computer.

An aspect of the invention relates to a method of key generation, signature generation and signature verification.

A method according to the invention may be implemented on a computer as a computer implemented method, or in dedicated hardware, or in a combination of both. Executable code for a method according to the invention may be stored on a computer program product. Examples of computer program products include memory devices, optical storage devices, integrated circuits, servers, online software, etc. Preferably, the computer program product comprises non-transitory program code means stored on a computer readable medium for performing a method according to the invention when said program product is executed on a computer.

In a preferred embodiment, the computer program comprises computer program code means adapted to perform all the steps of a method according to the invention when the computer program is run on a computer. Preferably, the computer program is embodied on a computer readable medium.

An electronic signature system is provided, comprising an electronic key generation device for generating a digital signing-key for digitally signing digital data and a corresponding verification-key for digitally verifying said digitally signed data, an electronic signature generation device for generating a digital signature for digital data using a digital signing-key obtained from an electronic key generation device, and an electronic signature verification device for verifying a digital signature generated by an electronic signature generation device. The verifier has access to a commitment integer and corresponding polynomial derived from private keying material, enabling verification of signature polynomials derived the same private keying material.

### BRIEF DESCRIPTION OF THE DRAWINGS

These and other aspects of the invention are apparent from and will be elucidated with reference to the embodiments described hereinafter. In the drawings,

FIG. 1a is a schematic block diagram of a signature system,

FIG. 1b is a schematic block diagram of a detail of public key generator 120,

FIG. 2 is schematic block diagram of an integrated circuit 400,

FIG. 3 is a schematic flow chart of a key generation method 500,

FIG. 4 is a schematic flow chart of a signature generation method 600,

FIG. 5 is a schematic flow chart of a signature verification method 700.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION OF EMBODIMENTS

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described.

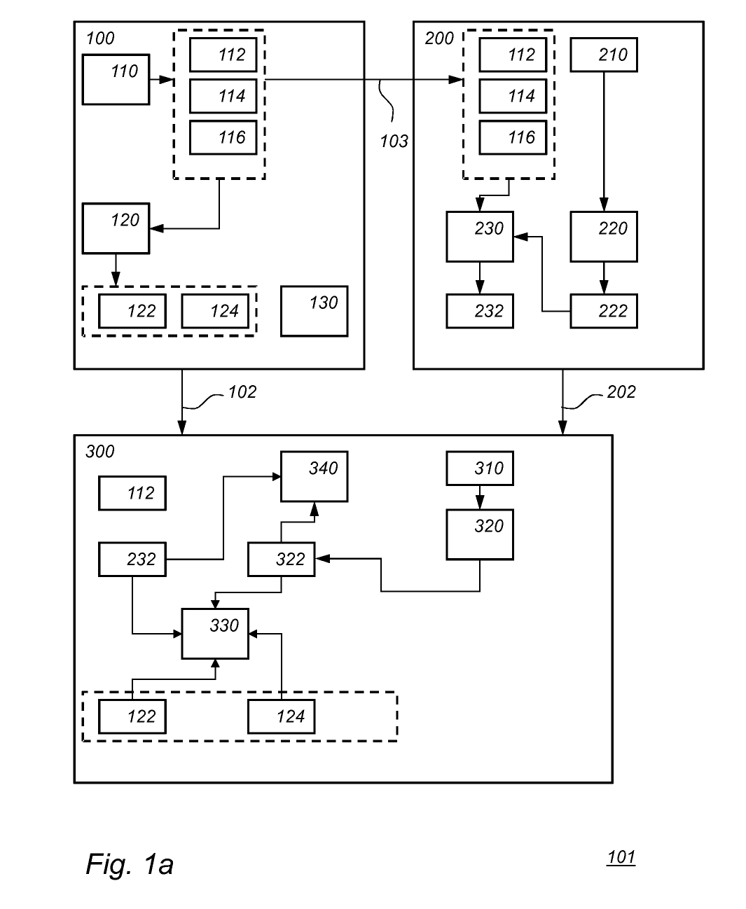

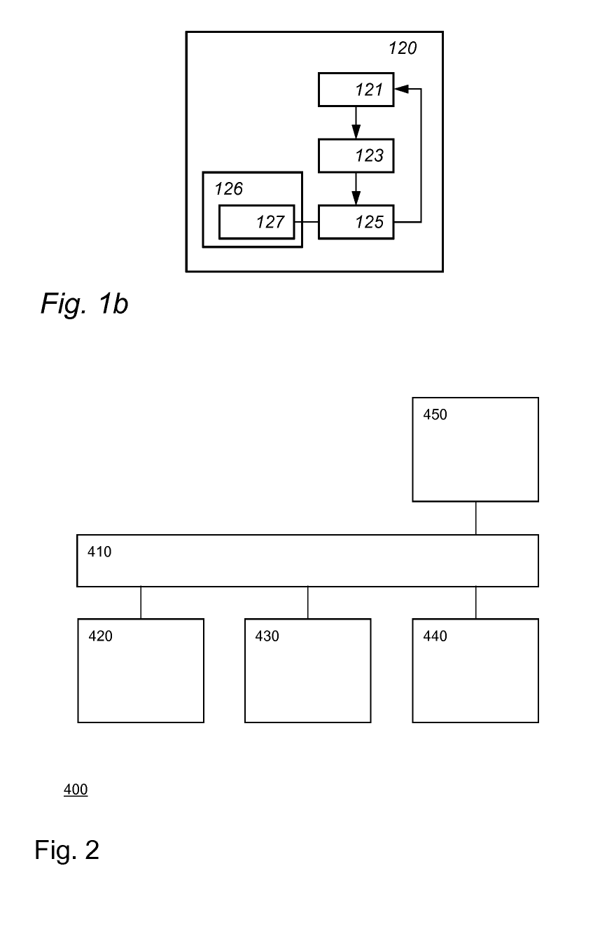

FIG. 1a illustrates with a schematic block diagram a signature system 101. Signature system 101 comprises an electronic key generation device 100, an electronic signature generation device 200 and electronic signature verification device 300.

Key generation device 100 generates the private key that is used by signature generation device 200 to generate digital signatures and the public key that is used by signature verification device 300 to verify them. The signature system is a so-called public-private key cryptosystem. Keys are generated in pairs: a public key and a private key. Knowledge of the private key enables a party to create a digital signature given some digital data. Knowledge of the public key enables a party to verify the signature. However, with access to only the public key one cannot generate signatures. The private key is also referred to as a digital signing-key, the public key as a verification-key.

The use of the adjectives public and private, is intended as helpful for understanding: Even with access to all public data, the private data cannot be computed, at least not without unreasonable high resources given the security of the application or compared to the resources needed for key generation, encryption and decryption. However, ‘public’ does not mean that the corresponding data is necessarily made available to anybody else than signature generation device 200 and signature verification device 300. In particular, keeping the public data secret from untrusted parties increases security. Likewise, access to private data may be restricted to the party that generated that data, this increase security. However, a trusted party may be allowed access to the private data; Access to private data compromises security. In system 101, key generation device 100 and signature generation device 200 have access to private data.

Key generation device 100 comprises a key material obtainer 110, a public key generator 120 and a key manager 130. Key material obtainer 110 is configured to obtain in electronic form a first private set of bivariate polynomials 116, referred to in formulas as fⱼ(,), a second private set of reduction integers 114, referred to as qⱼ and a public global reduction integer 112. The public global reduction integer 112 is different from each of the reduction integers; more preferably it is larger than each of the reduction integers in the second private set 114, qⱼ. With each bivariate polynomial in the first set there is associated a reduction integer of the second set.

During key generation each bivariate polynomial is evaluated modulo its associated reduction integer. The evaluated polynomials are then added, either in integer arithmetic or modulo public global reduction integer 112. This operation mixes computation in different rings. It is very hard to reconstruct the original second private set of reduction integers 114 or first private set of bivariate polynomials 116. Signature generation device 200 receives access to this secret information and can perform computations with it. Signature verification device 300 on the other hand does not receive access to second private set of reduction integers 114 and first private set of bivariate polynomials 116, accordingly it cannot perform the same computations as signature generation device 200. The system is designed, so that signature verification device 300 has sufficient information to verify the computations of signature generation device 200.

The bivariate polynomials 116 are preferably symmetric. In this case the implementation need not administrate which party should use which coordinate. Symmetry is however, not required, the system will work if first private set of bivariate polynomials 116 has one or more non-symmetric polynomials. For easy of exposition, it assumed that the polynomials in first private set of bivariate polynomials 116 are symmetric, keeping in mind that this is not needed.

The bivariate polynomials are defined over two variables. These are formal variables that have no meaning on their own. When a variable is not filled in, it will often be omitted. If writing the variables increases clarity, we refer to them as x and y. If only one variable is filled in, we will often select x. Note that for symmetric polynomials this is indifferent.

The number of polynomials is selected. The number of polynomials will be referred to as ‘m’. A practical choice for m is 2. A more secure application may use a higher value of m, say 3 or 4, or even higher.

Note that a low-complexity application, say for resource bounded devices may use m=1. The value m=1, although possible, is not recommended, and should only be considered for low security applications. Higher values of security parameters α and m increase the complexity of the system and accordingly increase its intractability. More complicated systems are harder to analyze and thus more resistant to cryptanalysis. Below it is assumed that m≧2.

There are different possible choices for public global reduction integer 112, second private set of reduction integers 114 and first private set of bivariate polynomials 116. Different choices cause the verification to be more or less powerful and accordingly, they cause the signatures to be shorter or longer depending on security requirements.

One particular advantageous choice is as follows. Public global reduction integer 112 is selected as an integer of (α+2)b bits, that is 2^{b(α+1)}≦N. Preferably, N has exactly this number of bits, so that N≦2^{b(α+2)}−1 Often the key length b, degree α and number of polynomials m will be pre-determined, e.g., by a system designer and provided to key material obtainer 110 as inputs. The public modulus may also be fixed, say in a standard, but more typically will be selected during generation of the parameters.

The reduction integers 114 may be selected so that the difference of any two of them has a common divisor, in particular as integers of the form qᵢ=N−βᵢ2^{b}, wherein the βᵢ are secret b-bit numbers.

The number α is the highest degree in a single variable of the bivariate polynomials in first private set of bivariate polynomials 116, e.g., this degree would be 2 for the polynomial x²y. The number b is a security parameter. It determines the amount of information that a single verification step gives on the authenticity of a signature. Higher values of b give more secure signatures. On the other hand with a low value of b, a single signature provides less information on the secret parameters, and this is also more secure. As a rule of thumb, higher values of b should be used with higher values of α.

For m>1, the system is more complicated, and thus more secure, since modulo operation for different moduli are combined even though such operations are not compatible in the usual mathematical sense. For this reason it is advantageous to choose the selected private moduli qⱼ as pairwise distinct.

A number of m bivariate polynomials f₁, f₂, . . . , fₘ of degrees αⱼ are generated. All degrees satisfy αⱼ≦α, and for at least one j, we have αⱼ=α. A better choice is to take each polynomial of degree α. A bivariate polynomial is a polynomial in two variables. A symmetric polynomial f satisfies f(x,y)=f(y,x). Each polynomial fⱼ has integer coefficients, and is evaluated in the finite ring formed by the integers modulo qⱼ, obtained by computing modulo qⱼ. In an embodiment the polynomial fⱼ is represented with coefficients from 0 up to qⱼ−1. The bivariate polynomials may be selected at random, e.g., by selecting random coefficients within these bounds.

The security of the signatures depend on the secrecy of these bivariate polynomials as they are the root keying material of the system; so preferably strong measures are taken to protect them, e.g., control procedures, tamper-resistant devices, and the like. Preferably the selected integers qⱼ are also kept secret, including the value βⱼ corresponding to qⱼ. We will refer to the bivariate polynomials also in the following form: for j=1, 2, . . . , m, we write fⱼ(x,y)=Σᵢ₌₀^{α}f_{i,j}(x)yⁱ.

The above embodiment can be varied in a number of ways. The restrictions on the public and private moduli may be chosen in a variety of ways, such that further obfuscation of the univariate polynomials is possible, yet that the signatures obtained remain sufficiently strong. What is sufficient will depend on the application, the required security level and the computing resources available at the devices. The above embodiment combines positive integers such that the modular operations which are carried out when generating the polynomials shares (i.e., the public polynomials and signature polynomials) are combined in a non-linear manner when they are added over the integers, creating a non-linear structure for the local key material stored on a network device. The above choice for N and qⱼ has the property that: (i) the size of N is fixed for all network devices and linked to α; (ii) the non-linear effect appears in the coefficients forming the key material stored on the device.

Key material obtainer 110 generates all or part of the key material and/or obtains all or part of the key material from an external source. For example, key material obtainer 110 is suited to receive the public global reduction integer 114 from an external source and generate the second private set of reduction integers 114 and first private set of bivariate polynomials 116 itself. The latter allows all network devices to be manufactured with a fixed public global reduction integer 112, reducing cost.

Key material obtainer 110 may comprise an electronic random number generator. The random number generator may be a true or pseudo random number generator. Key material obtainer 110 may generate a public global reduction integer, N, e.g., using the electronic random number generator. Although, the public global reduction integer is public information, introducing randomness makes analyzing the system more difficult.

Key generation device 100 may be a distributed system in which key material obtainer 110 is located at a different physical location than public key generator 120.

Key material obtainer 110 may generate one or more coefficients of a bivariate polynomial fᵢ(,) in a first private set 116, e.g., using the electronic random number generator. Key material obtainer 110 may generate all of the bivariate polynomial in this fashion. Key material obtainer 110 may use a maximum degree α of these polynomials, say 2, or 3 or higher, and generate one more random coefficient than the degree.

The first set 116 may contain two equal polynomials. This will work, however, unless the associated reduction integers are different the sets may be reduced in size. So typically, whenever two or more bivariate polynomials in the first set are the same, the associated reduction integers, i.e., the underlying ring, is different.

The number of polynomials in first private set 116 may be chosen differently depending on the application. The system will work when the first and second set contain only a single polynomial; in such a signatures may be successfully created and verified and provide a moderate level of security. However, the security advantage of mixing over different rings is only better when the first set has at least 2 polynomials in them, and the second set has at least two different reduction integers.

Private set 116 comprises at least one bivariate polynomial. In an embodiment of initiating key-agreement device 100 the private set 116 consists of one polynomial. Having only one polynomial in private set 116 reduces complexity, storage requirements and increases speed. However, having only one polynomial in private set 116 is considered less secure than having two or more polynomials in private set 116 because such a one-polynomial system does not profit from additional mixing in the summation. However, signatures will work correctly and are considered sufficiently secure for low-value and/or low-security applications.

In the remainder, we will assume that private set 116 comprises at least two symmetric bivariate polynomials. In an embodiment, at least two, or even all of the polynomials are different; this complicates analysis of the system considerably. It is not necessary though, private set 116 may comprise two equal polynomials and still benefit from mixing in the summation step if these two polynomials are evaluated over different rings. Note that different reduction integers define different rings. In an embodiment, private set 116 comprises at least two equal polynomials associated with different associated reduction integers. Having two or more equal polynomials in the first set reduces storage requirements. In an embodiment, the first set comprises at least two polynomials, and all polynomials in the first set are different.

The degrees of polynomials in private set 116 may be chosen differently depending on the application. Private set 116 comprises at least one symmetric bivariate polynomial of degree 1 or higher. In an embodiment, private set 116 comprises only polynomials of degree 1. Having only linear polynomials in private set 116 reduces complexity, storage requirements and increases speed. However, having only degree one polynomials in private set 116 is considered less secure than having at least one polynomial of degree at least two in private set 116 because such a system is considerably more linear. Even so, if multiple polynomials in private set 116 are evaluated over different rings, then the resulting encryption is not linear even if all polynomials in private set 116 are. In an embodiment, private set 116 comprises at least one, preferably two, polynomials of degree 2 or higher. However, key generation, encryption and decryption will work correctly if only degree 1 polynomials are used, and are considered sufficiently secure for low-value and/or low-security applications.

Having one or more polynomials in private set 116 with degree 0 will not impact the system, so long as the polynomial(s) with higher degree provide sufficient security.

For a mid-security application, private set 116 may comprise, or even consist of, two symmetric bivariate polynomials of degree 2. For a higher security application, private set 116 may comprise or even consist of two symmetric bivariate polynomials, one of degree 2 and one of degree higher than 2, say 3. Increasing the number of polynomials and/or their degrees will further increase security at the cost of increased resource consumption.

Preferably, the reduction integers are selected so that the difference of any two reduction integers in the same set of reduction integers has a common divisor. In particular, common divisor may be 2^{b}; or in words, the difference between any two reduction integers ends in a least b zero's, wherein b is a security parameter, e.g., that determines the number of bits that are compared during a matching step in verification.

For example, one way to generate the reduction integers and the public global reduction integer is as follows.
1. First generate the public global reduction integer N. For example as a random integer of prescribed size,
2. For each reduction integer, generate an integer βᵢ and generate the reduction integer qᵢ as the difference qᵢ=N−βᵢ2^{b}.

Key material obtainer 110 may be programmed in software or in hardware or in a combination thereof. Key material obtainer 110 may share resources with public key generator 120 for polynomial manipulation, e.g., a polynomial manipulation device. There are other possible choices for qᵢ and N.

Key generation device 100 comprises a public key generator 120 configured to obtain a third public set of commitment integers 122, also referred to as Pᵢ and to compute a corresponding univariate public polynomial KM_{P}_{ᵢ}(y) for each specific integer Pᵢ in the third public set. Third public set of commitment integers 122 may be selected as random b bit integers. Using the private data: second private set of reduction integers 114 and first private set of bivariate polynomials 116, public key generator 120 can compute a univariate public polynomial KM_{P}_{ᵢ}(y) for each commitment integer Pᵢ of the third public set of commitment integers 122; thus obtaining a set of univariate public polynomials KM_{P}_{ᵢ}(y) 124. The variable y is a formal variable.

To compute a KM_{P}_{ᵢ}(y) from a Pᵢ, public key generator 120 may proceed as follows. Public key generator 120 is configured to obtaining a further set of univariate polynomials by: for each particular polynomial of the first private set, substituting the specific integer (Pᵢ) into said particular polynomial (fⱼ(Pᵢ,)) and reducing modulo the reduction integer (qⱼ) associated with said particular polynomial. The further set of univariate polynomials is summed to obtain a single univariate polynomial KM_{P}_{ᵢ}(y). The summing may be done by adding the coefficients of equal powers of y in the polynomials. This may be obtained from the formula: KM_{P}_{ᵢ}(y)=Σⱼ₌₁^{m}<fⱼ(Pᵢ,y)>_{q}_{ⱼ}. The angle brackets indicate a modulo operation. Reduction modulo public global reduction integer 112 of the coefficients of KM_{P}_{ᵢ}(y)is not strictly necessary, but preferred, as it makes verification keys smaller. In the latter case we have:

$${KM}_{{P}_{i}} ( y ) = 〈 {\sum }_{j = 1}^{m} {〈 {f}_{j} ( {P}_{i} , y ) 〉}_{{q}_{{j}_{N}}}$$

After a substitution, public key generator 120 obtains fⱼ(Pᵢ,y). Public key generator 120 is further configured to reduce this term modulo qᵢ. Preferably, public key generator 120 brings the result into a canonical form, i.e., a predetermined standardized representation. A suitable canonical form is representation of the coefficient sorted by degrees of the monomials.

FIG. 1b shows one possible way to implement this function of public key generator 120. FIG. 1a shows a substituting unit 121, a polynomial reduction unit 123, a polynomial addition unit 125 and a sum of a set of univariate polynomials 126; the latter will be univariate public polynomial 127, KM_{P}_{ᵢ}(y). These may work as follows. Substituting unit 121 substitutes the commitment integer Pᵢ into a bivariate polynomial of first set 116. Substituting unit 121 may collect terms to bring the result in canonical form, but this may also wait. Polynomial reduction unit 123 receives the result of the substitution and reduces it modulo the reduction integer associated with the bivariate polynomial in which it was substituted.

The result of substituting the commitment integer Pᵢ into said particular polynomial fⱼ(Pᵢ,y) and reducing modulo the reduction integer qⱼ associated with said particular polynomial is represented as a list of coefficients in a canonical form before the summing by polynomial addition unit 125. Due to the reduction modulo qⱼ, each coefficient may be represented as an integer between 0 and qⱼ−1. The variable y acts as a formal variable. This substitution is sometimes notated simply as: fᵢ(Pᵢ, ).

Polynomial addition unit 125 receives the reduced univariate polynomials and adds them to a running total in sum 126. Sum 126 was reset to 0 prior to the generation of the univariate private key polynomial. Polynomial addition unit 125 may add the polynomials coefficient-wise, using either natural arithmetic or modulo the public global reduction number 112.

When all polynomials of the first private set are processed in this way, the result in sum 126 may be used as the univariate private key polynomial. The resulting univariate private key polynomial, say in sum 126, may be represented as a list of coefficients and in a canonical form.

The number of commitment integers depends on the desired security of the system. In an embodiment, there are multiple commitment integers, say at least 4, at least 8, etc. In an embodiment, the third public set of commitment integers (Pᵢ) comprises at least m(α+1) different commitment integers, wherein m is the number of polynomials in the first set and α is the highest degree in any of the two variables of the polynomials in the first set. With this number of commitment integers the amount of information (e.g. entropy) in set of univariate public polynomials 124 is about equal to the amount of information in first private set of bivariate polynomials 116, thus a unique signature given the root key material is expected. At this point, an attacker would do just as well to guess first private set of bivariate polynomials 116 as guessing a set of univariate public polynomials 124.

Key manager 130 is configured to make the first private set of bivariate polynomials 116, fⱼ(,) the second private set of reduction integers 114, qⱼ, available to an electronic signature generation device 200 for use as the signing-key to digitally sign digital data.

Key manager 130 is configured to make at least one commitment integer from the third public set of commitment integers 122 and the corresponding public polynomial computed by public key generator 120 available to an electronic signature verification device for use as the verification-key to digitally verify digital data signed by the signature generation device. Key manager 130 also makes the public global reduction integer (112,N) integer available to signature verification device 300.

In an embodiment, the key manager is configured to make the third public set of commitment integers 122 and all corresponding public polynomials 124 computed by the public key generator available to the electronic signature verification device. Having more elements in the third public set of commitment integers 122 and the set of univariate public polynomials 124 allows a better verification, and thus it is less likely that signature verification device 300 may be fooled by a fake signature. In some instances, signature verification device 300 may be able to derive sufficient trust based on fewer information, for example, if signature verification device 300 receives a commitment number of a special form, say, signature verification device 300's own identity number or derived there from, e.g. by hashing. In that case signature verification device 300 knows that the third public set of commitment integers 122 do not have a special property or form. In the typical embodiment, in communication 102, key manager 130 may send public global reduction integer 112, all of third public set of commitment integers 122, and all of the set of univariate public polynomials 124 to signature verification device 300.

Key manager 130 may use wireless communication for communication 103 or communication 102, say a Wi-Fi, Bluetooth or ZigBee connection. Key manager 130 may use a wired communication for communication 103 or communication 102, say a connection of a wired data network. Key manager 130 may also make the data available in other ways, say, by making it available for download, or by configuring signature generation device 200 and signature verification device 300 with the data, e.g., during manufacture, etc.

Signature generation device 200 is configured to generate a digital signature for digital data 210 using a digital signing-key obtained from an electronic key generation device 100. The signing-key may comprise second private set of reduction integers 114, first private set of bivariate polynomials 116 and optionally and preferably public global reduction integer 112. Signature generation device 200 has access to digital data 210, referred to as M. Using the signing key, signature generation device 200 can generate a signature that can be verified even without access to second private set of reduction integers 114 and first private set of bivariate polynomials 116. Data 210 may be a digital message, a digital command, and the like.

Signature generation device 200 comprises a hashing device 220, and a signature generator 230. Hashing device 220 has access to digital data 210 and is configured to determine a fourth set of hashes 222, hₖ by applying multiple different hash functions to the digital data (hₖ=hₖ(M)). Multiple hash functions may conveniently be built from a single hash function by concatenating digital data 210 with different values k. For example, one may define hₖ(M)=h(M ∥k) . Suitable hash functions are cryptographic hashes, e.g., sha-256, and the like. As an alternative one may chain a hash function: h₁(M)=h(M),h₂(M)=h(h(M)), . . . .

The number of hashes in fourth set of hashes 222 depends on the security of the system. In an embodiment, there are multiple hashes, say at least 4, at least 8, etc. In an embodiment, the fourth set of hashes 222 comprises at least m(α+1) different hashes. This number of hashes links the amount of information in second private set of reduction integers 114 and first private set of bivariate polynomials 116 to the amount of information in the signature.

Signature generator 230 is configured to compute a fifth set of univariate signature polynomials 232, S_{M,k}( ) for each specific hash (hₖ) in the fourth set. A univariate signature polynomial corresponding to the specific hash (hₖ) is computed from the specific hash and the first and second private sets 114, 116 by: obtaining a further set of univariate polynomials by: for each particular polynomial of the first private set, substituting the specific hash (hₖ) into said particular polynomial (fⱼ(hₖ, )) and reducing modulo the reduction integer associated with said particular polynomial (qⱼ), and summing the further set of univariate polynomials. The coefficients of the signature polynomials may be reduced modulo N. Although this is not necessary, it is preferred, as it makes the signature smaller.

Computing signature polynomials 232 from hashes 222 and second private set of reduction integers 114 and first private set of bivariate polynomials 116 uses the same procedure, e.g., as illustrated in FIG. 1b, as public key generator 120 uses to produce set of univariate public polynomials 124 from third public set of commitment integers 122, and second private set of reduction integers 114 and first private set of bivariate polynomials 116. If key generation device 100 and signature generation device 200 are the same device, then public key generator 120 and signature generator 230 may share this mechanism. The same variants that were described for public key generator 120 also apply to signature generator 230.

The generated digital signature comprises the fifth set of signature polynomial 232, S_{M,k}( )) generated by the signature key generator for the fourth set of hashes (hᵢ).

In the digital-signature system the private-key is difficult to recover from the public polynomials. The public key is linked to the private key, yet even given the public key, it is difficult to recover the private key. A signature proves that it could only have been generated by a device that has access to the private key.

Furthermore, even given many signatures and the public key, it is difficult to recover the private-key. In the system signature verification is done by verifying that the public-polynomials and signature polynomials fit with each other. Both the public-key components and the signature components include enough information linking them to a unique set of bivariate polynomials forming the root keying material. For this reason it is preferred to select the number of commitment integers and signature polynomials not too small.

Signature verification device 300 is configured to verifying a digital signature S_{M}( )generated by an electronic signature generation device. The signature verification device has access to at least one commitment integer Pᵢ and the at least one corresponding univariate public polynomial KM_{P}_{ᵢ}(y) generated by an electronic key generation device. Signature verification device 300 also has access to the digital signature comprising at least one univariate signature polynomial 232, S_{M,k}( ) and to digital data 310. Preferably, signature verification device 300 has access to multiple commitment integers Pᵢ and the corresponding univariate public polynomials KM_{P}_{ᵢ}(y) and multiple univariate signature polynomials 232, S_{M,k}( ). Digital data 310 should be the same as digital data 210, verifying the signature proves that the digital data 210 which signature generation device 200 used to generate the signature is the same as digital data 310 that is now available to signature verification device 300.

Signature verification device 300 comprises a hashing device 320 configured to determine a hash corresponding to a signature polynomial by applying a hash function to the digital data (hₖ=hₖ(M)). If digital data 310 and digital data 210 are equal, then hashing device 320 will produce set of verification hashes 322 which is equal to the fourth set of hashes 222. Note that fourth set of hashes polynomials 222 need not be made available from signature generation device 200 to signature verification device 300.

Signature verification device 300 may perform two types of checks on the signature. First, signature verification device 300 may check that the received signature corresponds to digital data 210 and to public key information: third public set of commitment integers 122, set of univariate public polynomials 124. Secondly, signature verification device 300 may check the internal consistency of fifth set of univariate signature polynomials 232, does this set of polynomials correspond to polynomials that could have been generated by a proper signature generation device 200? The first check is performed by a first signature verifier 330. The second test is performed by a consistency verifier 340. It is recommended that signature verification device 300 comprises consistency verifier 340, but with only signature verifier 330 signature verifications are possible.

Signature verifier 330 is configured to verify a match between the at least one univariate signature polynomial 232, S_{M,k}( )and the at least one univariate public polynomial 124.

Given a specific univariate signature polynomial S_{M,k}(y) and a specific univariate public polynomial KM_{P}_{ᵢ}(y), the following computations are performed:

Substituting the hash hₖ, computed by hashing device 320, corresponding to the specific signature polynomial S_{m,k}( ) in the specific public polynomial and reducing modulo public global reduction integer 112, thus obtaining a first substitution result: KM_{P}_{ᵢ}(hₖ).

Substituting the commitment integer Pᵢ corresponding to the specific public polynomial KM_{P}_{ᵢ}(y) in the specific signature polynomial S_{M,k}(y) and reducing modulo public global reduction integer 112 obtaining a second substitution result: S_{M,k}(Pᵢ).

Verifying that the first substitution result KM_{P}_{ᵢ}(hₖ) matches the second substitution result S_{M,k}(Pᵢ).

If first private set of bivariate polynomials 116 contains only a single bivariate polynomial the first and second substitution results are equal in case of a valid signature In that case a match can be verified by testing for equality. However, if first private set of bivariate polynomials 116 comprises multiple bivariate polynomials, these two results are not necessarily equal. In that case verifying a match should allow for some difference between the first and second substitution result.

For example, one may verify that there exist a multiple of the public global reduction integer so that adding the multiple to the first substitution results equals the second substitution results, at least in a predetermined number of least significant bits, e.g., b bits. In formula's, one may test that Kᵢ= [symbol] K₂+jN [symbol] ₂_{^{b}}, wherein |j| is less than a predetermined bound. The latter bound depends on the exact choice of reduction integers, and how the result of the summing is used, e.g. complete or partial, reduced or unreduced. A particularly advantageous implementation applies both reduction modulo the public global reduction integer and removes part of one or more coefficients.

Note that adding polynomials reduced over different reduction integers introduces non-linearity.

Signature verifier 330 can perform the above test, for all combinations of a univariate signature polynomial S_{M,k}(y) and a univariate public polynomial KM_{P}_{ᵢ}(y). If resources are low and security requirements are low, then signature verifier 330 could verify this test for a selection of the combinations, say a random sample. If signature verifier 330 finds a pair that fails the match then it is established that fifth set of univariate signature polynomials 232 was not produced by the correct private key or that message digital data 210 changed after signing (or both).

Consistency verifier 340 is configured to verify a consistency between the at least two univariate signature polynomials 229, S_{M,j}(y), S_{M,k}(y)). Like signature verifier 330 a test is performed for pairs of polynomials, in this case pairs of univariate signature polynomial.

For a specific first and (different) second univariate signature polynomial, consistency verifier 340 performs the following test:

Substitute the hash value hⱼ corresponding to the first specific signature polynomial S_{M,j}(y), in the second specific signature polynomial S_{M,k}(y) obtaining a first substitution result: S_{M,k}(hⱼ).

Substitute the hash value hₖ corresponding to the second specific signature polynomial S_{M,k}(y), in the first specific signature polynomial S_{M,j}(y) obtaining a second substitution result: S_{M,j}(hₖ). Subsequently, the first and second substitution results are verified, as explained below.

Here the first and second substitution results are also referred to as first and second consistency result.

Consistency verifier 340 can perform the above test, for all combinations of two univariate signature polynomials S_{M,k}(y). If resources are low and security requirements are low, then consistency verifier 340 could verify this test for a selection of combinations, say a random sample. If consistency verifier 340 finds a pair that fails the match then it is established that fifth set of univariate signature polynomials 232 was not produced from a valid private key following the procedure of signature generation device 200.

Verifying a match between a first and second substitution result may be done in the same way for signature verifier 330 as for consistency verifier 340. Signature verification device 300 may comprise a matching unit (not separately shown) which may be used by signature verifier 330 and consistency verifier 340.

The matching unit is configured to verify a match by verifying existence of a multiplier (j) such that a predetermined number of least significant bits (b) of the first substitution result plus the multiplier times the public global reduction integer (jN) equals the predetermined number of least significant bits (b) of the second substitution result. Equivalently, the matching unit may be is configured to verifying a match by verifying existence of a multiplier (j) such that a predetermined number of least significant bits (b) of the second substitution result plus the multiplier times the public global reduction integer (jN) equals the predetermined number of least significant bits (b) of the first substitution result. Both options give the same results.

Given reduction integers of the form N−βᵢ2^{b}, and referring to the first and second substitution result as K₁ and K₂, we have that in case of a match K₁= [symbol] K₂+jN [symbol] ₂_{^{b}}, wherein |j|≦(3m−1). This formula may be verified for all values of j, to establish or reject a match. If the reduction integers are chosen differently, the bound on j, may need to be extended.

Consistency verifier 340 may be embodied as part of signature verifier 330.

Various combinations of key generation device 100, signature generation device 200 and signature verification device 300 may be made. For example, key generation device 100 and signature generation device 200 may be integrated in a single device. One may even combine key generation device 100, signature generation device 200 and signature verification device 300 in a single device, even for the same key. This may be useful, to protect, e.g., a backup system in which backups are signed before storage and later verified with retrieval.

In an embodiment, referring to the number of hashes as r and the number commitment integers as s, a bound on r and s is given by rs+s(s−1)/2≧m(α+1)(α+2)/2. This number relates the amount of information obtained during verification to the amount of information in the root keying material. This bound is typically weaker than the bound given above, slightly weaker but smaller signatures are obtained.

Typically, the devices 100, 200 and 300 each comprise a microprocessor (not shown) which executes appropriate software stored at the device 100, 200 and 300; for example, that software may have been downloaded and/or stored in a corresponding memory, e.g., a volatile memory such as RAM or a non-volatile memory such as Flash (not shown). Alternatively, the devices 100, 200 and 300 may, wholly or partially, be implemented in programmable logic, e.g., as field-programmable gate array (FPGA).

In an embodiment, a special case is used that has implementation advantages. The bivariate polynomials are all monomials of the form fᵢ(x,y)=Aᵢx^{α}y^{α}, In this case, the root keying material consists of m integers, each of size (α+2)b, so the root keying material comprises m(α+2)b bits. Using a similar argument we may set bound on r and s as follows: rs+s(s+1)/2>m(α+2) and

$$r > \frac{m ( a + 2 )}{s} - ( s - 1 ) / 2.$$

By setting the parameters in this way, the set of public and private components identify in the secret root keying material for a given value of r, s, and check points. In other words, only someone owning the root keying material could generate the private components so that all the checks are passed.

We remark that each component of the signature is now a monomial. The security of the scheme relies thus on the facts that the disclosed functions (public and private components) determine the root keying material in a quite unique way but it is difficult to recover the root keying material from them. If someone does not have the functions of the root keying material, he will not be able to pass all the checks. Setting m=2 is the good choice in order to reduce the number of checks and the length of the public key and private keys. Having m=1 is much less secure because then there is no mixing of modular operations. A low a value may be used for complexity reasons, but not for security reasons. For security a large α is preferred. For example, α must be large to avoid lattice attacks. Lattice attacks work less well for smaller b, so for small b α can be smaller.

However, keeping m and a too small may allow for a different type of attack. An attacker may try to create his own set of moduli, \tilde{q}ᵢ and keying material polynomials, that although different sufficiently often produce signatures that pass the test for the correct parameters. It appears this attack is more likely if r is small.

In the embodiment above, the public polynomials and signature polynomials were obtained by summing a certain set of univariate polynomials. In this case coefficients in monomials of corresponding degree are added together. It is however possible to ignore part of the coefficients after summing and reduction modulo the public global reduction integer (N). This significantly reduces of the size of the public polynomials and signature polynomials. This option may be used either for the public polynomials, for the signature polynomials or for both, the latter option giving the largest reduction in size.

In a preferred embodiment, the amount of bits required to represent the public keys and the signature polynomials is halved (see below).

The reduction of the number of bits for representing the coefficient of a polynomial f is achieved as follows. Instead of the coefficients of the polynomial f(x)=Σᵢ₌₀^{α}fᵢxⁱ, we use the coefficients of the polynomial \tilde{f}(x)=Σᵢ₌₀^{α}\tilde{f}ₗxⁱ, where for each i, the coefficient \tilde{f}ₗ consists of the ibmost significant bits of fᵢ and the b least significant bits of fᵢ. So for example, with α=2, we write f₀=f_{0,0}+f_{0,1}2^{b}+f_{0,2}2^{2b}+f_{0,3}2^{3b}, f₁=f_{1,0}+f_{1,1}2^{b}+f_{1,2}2^{2b}+f_{1,3}2^{3b}, f₂=f_{2,0}+f_{2,1}2^{2b}+f_{2,3}2^{3b}, where for all i, j, we have that 0≦f_{i,j}≦2^{b}−1. Then \tilde{f}₀=f₀, \tilde{f}₁=f_{1,0}+f₁₃2^{3b}, \tilde{f}₂=f_{2,0}+f_{2,2}2^{2b}+f_{2,3}2^{3b}.

The matching step in the verification steps is modified: now we only require that |j|≦3m+2α (instead of |j|≦3m−1). Since the bound on j is larger, a matching will be obtained more easily. This relaxed requirement on |j|, may make it somewhat easier to forge signatures. To counterbalance this, the number of public key polynomials and/or the number of signature polynomials may be slightly increased. The above bounds assume that the corresponding polynomial (public or signature) has been reduced modulo the public global reduction integer before it is further reduced by removing parts of its coefficients.

Alternatively, we can increase the number of bits to use of each coefficient. For example, one may use from fᵢ the (ib+1) most significant bits and the b least significant bits. If we do so, we need (α+1) more bits as compared to the preferred embodiment above, but the requirement on j becomes stricter as well: it is now required that |j|≦3m+α.

FIG. 2 is schematic block diagram of an integrated circuit 400. Integrated circuit 400 comprises a processor 420, a memory 430, and an I/O unit 440. These units of integrated circuit 400 can communicate amongst each other through an interconnect 410, such as a bus. Processor 420 is configured to execute software stored in memory 430 to execute a method as described herein. In this way integrated circuit 400 may be configured as a key generation device 100, signature generation device 200 and/or signature verification device 300; Part of memory 430 may then store data as required, including, e.g., public global reduction integer 112, second private set of reduction integers 114, first private set of bivariate polynomials 116, digital data 210, fourth set of hashes 222, fifth set of univariate signature polynomials 232, digital data 310, and set of verification hashes 322, etc.

I/O unit 440 may be used to communicate with other devices such as devices 100, 200 or 300, for example for communications 102, 103, and 202. I/O unit 440 may comprise an antenna for wireless communication. I/O unit 440 may comprise an electric interface for wired communication.

Integrated circuit 400 may be integrated in a computer, mobile communication device, such as a mobile phone, etc. Integrated circuit 400 may also be integrated in lighting device, e.g., arranged with an LED device. For example, an integrated circuit 400 configured as as signature verification device 300 and arranged with lighting unit such as an LED, may receive commands authenticated with a private key and verify the command with a public key. The device may fail to execute the command, say turn on the LED etc, if the signature verification fails.

Although polynomial manipulation may be performed by processor 420 as instructed by polynomial manipulation software stored in memory 430, the tasks of key generation, calculating the univariate polynomials and substitutions are faster if integrated circuit 400 is configured with optional polynomial manipulation device 450. Polynomial manipulation device 450 is a hardware unit for executing substitution and reduction operations.

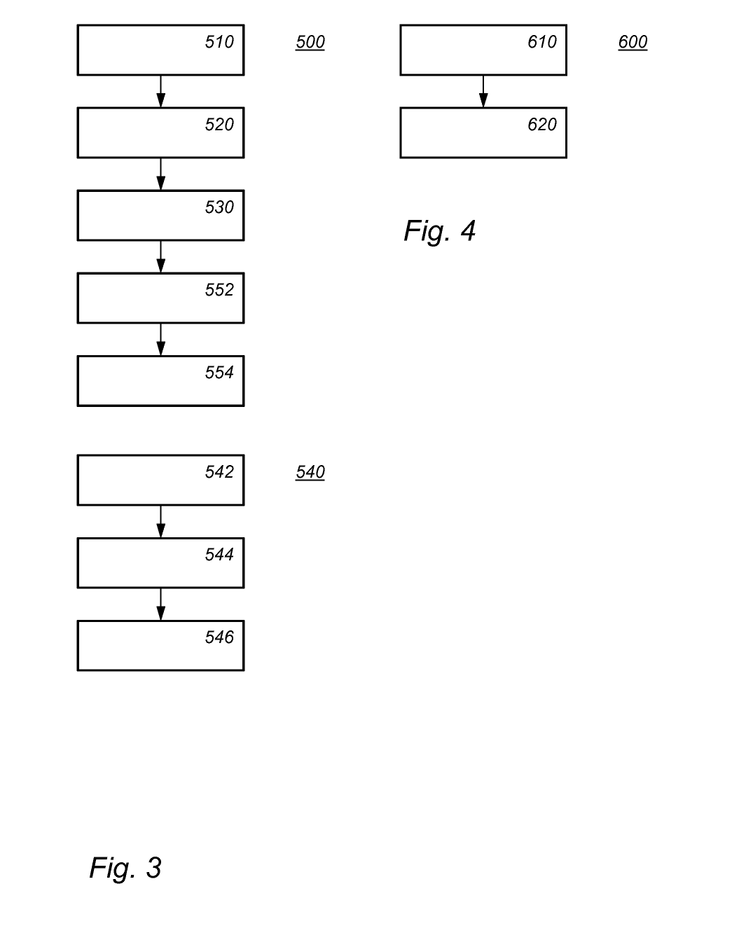

FIG. 3 illustrates with a schematic flow chart an electronic key generation method 500 for generating a digital signing-key for digitally signing digital data and a corresponding verification-key for digitally verifying said digitally signed data. Key generation method 500 comprising:

Obtaining 510 in electronic form a public global reduction integer (112, N), a first private set of bivariate polynomials (116, fⱼ(,)) and a second private set of reduction integers (114, qⱼ), with each bivariate polynomial in the first set there is associated a reduction integer of the second set,

Obtain 520 a third public set of commitment integers (122, P ᵢ)

Compute 530 a corresponding univariate public polynomial (124, KM_{P}_{ᵢ}(y)) for each specific integer (Pᵢ) in the third public set.

Make 552 the first private set of bivariate polynomials (116, fⱼ(,)), the second private set of reduction integers (114, qⱼ), available to an electronic signature generation device for use as the signing-key to digitally sign digital data, and to

Make 554 at least one of the public polynomials computed by the public key generator from the third public set of commitment integers available to an electronic signature verification device for use as the verification-key to digitally verify digital data signed by the signature generation device.

In step 530, a univariate public polynomial can be computed from the specific integer and the first and second private sets by sub method 540:

Obtaining 542 a further set of univariate polynomials by: for each particular polynomial of the first private set, substituting the specific integer (Pᵢ) into said particular polynomial (fⱼ(Pᵢ,)) and reducing modulo the reduction integer associated with said particular polynomial, and

Summing 544 the further set of univariate polynomials,

Reducing 546 the result of summing the further set of univariate polynomials modulo the public global reduction integer 112.

FIG. 4 illustrates with a schematic flow chart an electronic signature generation method 600 for generating a digital signature for digital data (M) using a digital signing-key obtained from an electronic key generation method. The signature generation device method comprising:

Hashing 610 to determine a fourth set of hashes (222, hₖ) by applying multiple different hash functions to the digital data (hₖ=hₖ(M)),

Compute 620 a fifth set of univariate signature polynomials (232, S_{M,k}( )) for each specific hash (hₖ) in the fourth set, a univariate signature polynomial corresponding to the specific hash (hₖ) being computed from the specific hash and the first and second private sets.

A univariate signature polynomials can be computed by applying sub-method 540, reading hash instead of commitment integer.

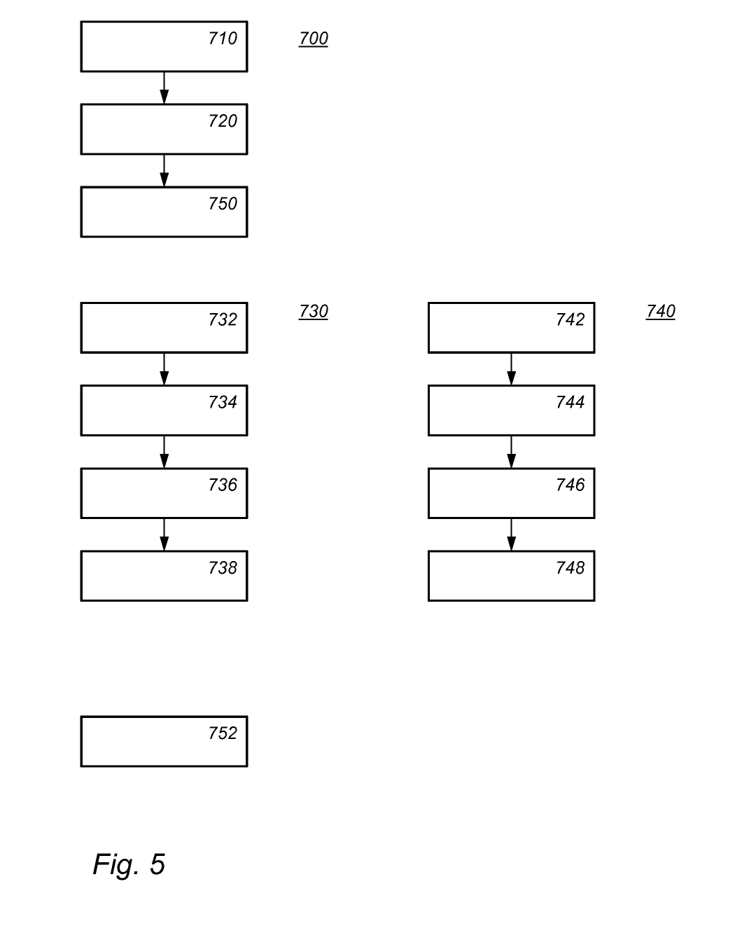

FIG. 5 illustrates with a schematic flow chart an electronic signature verification method 700 for verifying a digital signature (S_{M}( )) generated by an electronic signature generation method,

Hashing 710 to determine a hash (322) corresponding to a signature polynomial by applying a hash function to the digital data (hₖ=hₖ(M)),

Verify 720 a match between the at least one univariate signature polynomial (232, S_{M,k}( )) and the at least one univariate public polynomial, by for a specific univariate signature polynomial of the at least one univariate signature polynomial and a specific univariate public polynomial of the at least one univariate public polynomial.

Verifying one pair of univariate signature polynomial and univariate public polynomial may use sub-method 730:

Substituting 732 the hash corresponding to the specific signature polynomial in the specific public polynomial, thus obtaining a first substitution result

Substituting 734 the commitment integer corresponding to the specific public polynomial in the specific signature polynomial obtaining a second substitution result,

Reduce 736 the first and second substitution result modulo the public global reduction integer (N) before verifying that first and second substitution results match.

Verifying 738 that the first substitution result matches the second substitution result, wherein the signature verification device requires a match to verify the digital signature (S_{M}( )). Verifying a match may be done as described herein.

The method 700 may further verify 750 a consistency between the at least two univariate signature polynomials (229, S_{Mj}( ), S_{M,k}( )), by for a first and second specific univariate signature polynomial of the at least two univariate signature polynomials. This may use sub-method 740:

Substitute 742 the hash value corresponding to the first specific signature polynomial in the second specific signature polynomial obtaining a first consistency result,

Substitute 744 the hash value corresponding to the second specific signature polynomial in the first specific signature polynomial obtaining a second consistency result,

Reduce 746 the first and second substitution result modulo the public global reduction integer (N) before verifying that first and second substitution results match.

Verifying 748 that the first consistency result matches the second consistency result, wherein the signature verification device requires a match to verify the digital signature (S_{M}( )).

Both methods 730 and 740 may use sub-method 752 to establish a match.

Verifying 752 existence of a multiplier (j) such that a predetermined number of least significant bits (b) of the first substitution result plus the multiplier times the public global reduction integer (jN) equals the predetermined number of least significant bits (b) of the second substitution result.

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. For example, some steps may be executed, at least partially, in parallel. Moreover, a given step may not have finished completely before a next step is started.

A method according to the invention may be executed using software, which comprises instructions for causing a processor system to perform method 500, 600 and/or 700. Software may only include those steps taken by a particular sub-entity of the system. The software may be stored in a suitable storage medium, such as a hard disk, a floppy, a memory etc. The software may be sent as a signal along a wire, or wireless, or using a data network, e.g., the Internet. The software may be made available for download and/or for remote usage on a server. A method according to the invention may be executed using a bitstream arranged to configure programmable logic, e.g., a field-programmable gate array (FPGA), to perform a method according to the invention.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

### LIST OF REFERENCE NUMERALS

100 key generation device
101 a signature system
102 a communication
103 a communication
110 a key material obtainer
112 a public global reduction integer N
114 a second private set of reduction integers qⱼ
116 a first private set of bivariate polynomials fⱼ(,)
120 a public key generator
121 a substituting unit
122 a third public set of commitment integers Pᵢ
123 a polynomial reduction unit
124 a set of univariate public polynomial KM_{P}_{ᵢ}(y)
125 a polynomial addition unit
126 a sum of a set of univariate polynomials
127 a univariate public polynomial
130 a key manager
200 a signature generation device
202 a communication
210 digital data M
220 a hashing device
222 a fourth set of hashes hₖ
230 a signature generator
232 a fifth set of univariate signature polynomials S_{M,k}( )
300 signature verification device
310 digital data M
320 a hashing device
322 a set of verification hashes hₖ=hₖ(M)
330 a signature verifier
340 a consistency verifier
400 an integrated circuit
410 an interconnect
420 a processor
430 a memory
440 an I/O unit
450 a polynomial manipulation device

1. An electronic key generation device for generating a digital signing-key for digitally signing digital data and a corresponding verification-key for digitally verifying said digitally signed data, the key generation device comprising
a key material obtainer for
obtaining in electronic form a first private set of bivariate polynomials (116, fⱼ(,)) and a second private set of reduction integers (114, qⱼ), with each bivariate polynomial in the first set there is associated a reduction integer of the second set,
a public key generator configured to
obtain a third public set of commitment integers (122, Pᵢ) and to compute a corresponding univariate public polynomial (124, KM_{P}_{ᵢ}(y)) for each specific integer (Pᵢ) in the third public set, a univariate public polynomial being computed from the specific integer and the first and second private sets by:
obtaining a further set of univariate polynomials by: for each particular polynomial of the first private set, substituting the specific integer (Pᵢ) into said particular polynomial (fⱼ(Pᵢ,)) and reducing modulo the reduction integer associated with said particular polynomial, and
summing the further set of univariate polynomials, and
a key manager configured to
make the first private set of bivariate polynomials (116, fⱼ(,)), the second private set of reduction integers (114, qⱼ), available to an electronic signature generation device for use as the signing-key to digitally sign digital data, and to
make at least part of at least one of the public polynomials computed by the public key generator from the third public set of commitment integers available to an electronic signature verification device for use as the verification-key to digitally verify digital data signed by the signature generation device.

2. An electronic key generation device as in claim 1, wherein
the key material obtainer is configured to further obtain a public global reduction integer (112, N) larger than each of the reduction integers in the second private set (114, qⱼ),
the public key generator is configured to reduce the result of the summing of the further set of univariate polynomials modulo the public global reduction integer (112, N), and
the key manager is configured to make the public global reduction integer available to the signature verification device.

3. An electronic key generation device as in claim 2, wherein the key generation device is configured to reduce the bit-size of the at least one of the public polynomials by removing at least part of the bits of at least one coefficient before making the at least part of at least one of the public polynomials available to the electronic signature verification device.

4. An electronic key generation device as in claim 1, wherein
the key manager is configured to make the third public set of commitment integers and all corresponding public polynomials computed by the public key generator available to the electronic signature verification device.

5. An electronic key generation device as in claim 4, wherein the third public set of commitment integers (Pᵢ) comprises at least m(α+1) different commitment integers, wherein m is the number of polynomials in the first set and α is the highest degree in any of the two variables of the polynomials in the first set.

6. An electronic signature generation device for generating a digital signature for digital data (M) using a digital signing-key obtained from an electronic key generation device as in claim 1, the signature generation device comprising
a hashing device configured to determine a fourth set of hashes (222, hₖ) by applying multiple different hash functions to the digital data (hₖ=hₖ(M)),
a signature generator configured to compute univariate signature polynomials (232, S_{M,k}( )) for each specific hash (hₖ) in the fourth set, a univariate signature polynomial corresponding to the specific hash (hₖ) being computed from the specific hash and the first and second private sets by:
obtaining a further set of univariate polynomials by: for each particular polynomial of the first private set, substituting the specific hash (hₖ) into said particular polynomial (fⱼ(hₖ, )) and reducing modulo the reduction integer associated with said particular polynomial (fⱼ), and
summing the further set of univariate polynomials,
wherein said generated digital signature comprises a fifth set of signature polynomials (232, S_{M,k}( )) comprising at least part of each signature polynomial generated by the signature key generator for the fourth set of hashes (hᵢ).

7. An electronic signature generation device as in claim 6 having access to a public global reduction integer generated by an electronic key generation device for generating a digital signing-key for digitally signing digital data and a corresponding verification-key for digitally verifying said digitally signed data, the key generation device comprising
a key material obtainer for
obtaining in electronic form a first private set of bivariate polynomials (116, fⱼ(,)) and a second private set of reduction integers (114, qⱼ), with each bivariate polynomial in the first set there is associated a reduction integer of the second set,
a public key generator configured to
obtain a third public set of commitment integers (122, Pᵢ) and to compute a corresponding univariate public polynomial (124, KM_{P}_{ᵢ}(y)) for each specific integer (Pᵢ) in the third public set, a univariate public polynomial being computed from the specific integer and the first and second private sets by:
obtaining a further set of univariate polynomials by: For each particular polynomial of the first private set, substituting the specific integer (Pᵢ) into said particular polynomial (fⱼ(Pᵢ,)) and reducing modulo the reduction integer associated with said particular polynomial, and
summing the further set of univariate polynomials, and
a key manager configured to
make the first private set of bivariate polynomials (116, fⱼ(,)), the second private set of reduction integers (114, qⱼ), available to an electronic signature generation device for use as the signing-key to digitally sign digital data, and to
make at least part of at least one of the public polynomials computed by the public key generator from the third public set of commitment integers available to an electronic signature verification device for use as the verification-key to digitally verify digital data signed by the signature generation device, wherein
the key material obtainer is configured to further obtain a public global reduction integer (112, N) larger than each of the reduction integers in the second private set (114, qⱼ),
the public key generator is configured to reduce the result of the summing of the further set of univariate polynomials modulo the public global reduction integer (112, N), and
the key manager is configured to make the public global reduction integer available to the signature verification device,
wherein
the signature generator is configured to reduce the result of the summing of the further set of univariate polynomials modulo the public global reduction integer (112, N), and
the electronic signature generation device is configured to reduce the bit-size of at least one of the signature polynomials by removing at least part of the bits of at least one coefficient.

8. An electronic signature generation device as in claim 6 wherein the fourth set of hashes (hₖ) comprises at least m(α+1) different hashes, wherein m is the number of polynomials in the first set and α is the highest degree in any of the two variables of the polynomials in the first set.

9. An electronic signature verification device for verifying a digital signature (S_{M}( )) generated by an electronic signature generation device as in claim 6, the signature verification device having access to at least one commitment integer and the at least one corresponding univariate public polynomial generated by an electronic key generation device for generating a digital signingkey for digitally signing digital data and a corresponding verification-key for digitally verifying said digitally signed data, the key generation device comprising
a key material obtainer for
obtaining in electronic form a first private set of bivariate polynomials (116, fⱼ(,)) and a second private set of reduction integers (114, qⱼ), with each bivariate polynomial in the first set there is associated a reduction integer of the second set,
a public key generator configured to
obtain a third public set of commitment integers (122, Pᵢ) and to compute a corresponding univariate public polynomial (124, KM_{P}_{ᵢ}(y)) for each specific integer (Pᵢ) in the third public set, a univariate public polynomial being computed from the specific integer and the first and second private sets by:
obtaining a further set of univariate polynomials by: for each particular polynomial of the first private set, substituting the specific integer (Pᵢ) into said particular polynomial (fⱼ(Pᵢ,)) and reducing modulo the reduction integer associated with said particular polynomial, and
summing the further set of univariate polynomials, and
a key manager configured to
make the first private set of bivariate polynomials (116, fⱼ(,)), the second private set of reduction integers (114, qⱼ), available to an electronic signature generation device for use as the signingkey to digitally sign digital data, and to
make at least part of at least one of the public polynomials computed by the public key generator from the third public set of commitment integers available to an electronic signature verification device for use as the verification-key to digitally verify digital data signed by the signature generation device,
the digital signature comprising at least one univariate signature polynomial (232, S_{M,k}( )),
a hashing device (320) configured to determine a hash (322) corresponding to a signature polynomial by applying a hash function to the digital data (hₖ=hₖ(M)),
a signature verifier configured to verify a match between the at least one univariate signature polynomial (232, S_{M,k}( )) and the at least one univariate public polynomial, by for a specific univariate signature polynomial of the at least one univariate signature polynomial and a specific univariate public polynomial of the at least one univariate public polynomial,
substituting the hash corresponding to the specific signature polynomial in the specific public polynomial, thus obtaining a first substitution result
substituting the commitment integer corresponding to the specific public polynomial in the specific signature polynomial obtaining a second substitution result,
verifying that the first substitution result matches the second substitution result, wherein the signature verification device requires a match to verify the digital signature (S_{M}( )).

10. An electronic signature verification device as in claim 9, wherein the digital signature comprises at least two univariate signature polynomials (232, S_{M,k}( )),
the signature verifier is configured to verify a consistency between the at least two univariate signature polynomials (229, S_{M,j}( ), S_{M,k}( )), by for a first and second specific univariate signature polynomial of the at least two univariate signature polynomials:
substitute the hash value corresponding to the first specific signature polynomial in the second specific signature polynomial obtaining a first substitution result,
substitute the hash value corresponding to the second specific signature polynomial in the first specific signature polynomial obtaining a second substitution result,
verifying that the first consistency result matches the second consistency result, wherein the signature verification device requires a match to verify the digital signature (S_{M}( )).

11. An electronic signature verification device as in claim 9, the signature verification device having access to a public global reduction integer generated by an electronic key generation device for generating a digital signing-key for digitally signing digital data and a corresponding verification-key for digitally verifying said digitally signed data, the key generation device comprising
a key material obtainer for
obtaining in electronic form a first private set of bivariate polynomials (116, fₖ(,)) and a second private set of reduction integers (114, qⱼ), with each bivariate polynomial in the first set there is associated a reduction integer of the second set,
a public key generator configured to
obtain a third public set of commitment integers (122, Pᵢ) and to compute a corresponding univariate public polynomial (124, KM_{P}_{ᵢ}(y)) for each specific integer (Pᵢ) in the third public set, a univariate public polynomial being computed from the specific integer and the first and second private sets by:
obtaining a further set of univariate polynomials by: for each particular polynomial of the first private set, substituting the specific integer (Pᵢ) into said particular polynomial (fⱼ(Pᵢ,)) and reducing modulo the reduction integer associated with said particular polynomial, and
summing the further set of univariate polynomials, and
a key manager configured to
make the first private set of bivariate polynomials (116, fⱼ(,)), the second private set of reduction integers (114, qⱼ), available to an electronic signature generation device for use as the signing-key to digitally sign digital data, and to
make at least part of at least one of the public polynomials computed by the public key generator from the third public set of commitment integers available to an electronic signature verification device for use as the verification-key to digitally verify digital data signed by the signature generation device, wherein
the key material obtainer is configured to further obtain a public global reduction integer (112, N) larger than each of the reduction integers in the second private set (114, qⱼ),
the public key generator is configured to reduce the result of the summing of the further set of univariate polynomials modulo the public global reduction integer (112, N), and
the key manager is configured to make the public global reduction integer available to the signature verification device,
wherein
the signature verifier is configured to reduce the first and second substitution result modulo the public global reduction integer (N) before verifying that first and second substitution results match.

12. An electronic signature verification device as in claim 11, wherein
the signature verifier is configured to verify a match by verifying existence of a multiplier (f), smaller than a predetermined bound, such that a predetermined number of least significant bits (b) of the first substitution result plus the multiplier times the public global reduction integer (fN) equals the predetermined number of least significant bits (b) of the second substitution result, or
the signature verifier is configured to verify a match by verifying existence of a multiplier (f), smaller than a predetermined bound, such that a predetermined number of least significant bits (b) of the second substitution result plus the multiplier times the public global reduction integer (jN) equals the predetermined number of least significant bits (b)of the first substitution result.

13. An electronic key generation method for generating a digital signing-key for digitally signing digital data and a corresponding verification-key for digitally verifying said digitally signed data, the key generation method comprising
obtaining key material including:
obtaining in electronic form, a first private set of bivariate polynomials (116, fⱼ(,)), and a second private set of reduction integers (114, qⱼ), with each bivariate polynomial in the first set there is associated a reduction integer of the second set,
generating a public key including:
obtaining a third public set of commitment integers (Pᵢ) and computing a corresponding univariate public polynomial (124, KM_{P}_{ᵢ}(y)) for each specific integer (Pᵢ) in the third public set, a univariate public polynomial being computed from the specific integer and the first and second private sets by:
obtaining a further set of univariate polynomials by: for each particular polynomial of the first private set, substituting the specific integer (Pᵢ) into said particular polynomial (fⱼ(Pᵢ,)) and reducing modulo the reduction integer associated with said particular polynomial, and
summing the further set of univariate polynomials, and
managing the key including:
making the first private set of bivariate polynomials (116, fⱼ(,)), the second private set of reduction integers (114, qⱼ), available to an electronic signature generation device for use as the signing-key to digitally sign digital data, and
making at least part of at least one of the public polynomials computed by the public key generator from the third public set of commitment integers available to an electronic signature verification device for use as the verification-key to digitally verify digital data signed by the signature generation device.

14. An electronic signature generation method for generating a digital signature for digital data (M) using a digital signing-key obtained from an electronic key generation method as in claim 13, the signature generation method comprising
hashing to determine a fourth set of hashes (222, hₖ) by applying multiple different hash functions to the digital data (hₖ=hₖ(M)),
generating a signature including computing univariate signature polynomials (232, S_{M,k}( )) for each specific hash (hₖ) in the fourth set, a univariate signature polynomial corresponding to the specific hash (hₖ) being computed from the specific hash and the first and second private sets by:
obtaining a further set of univariate polynomials by: for each particular polynomial of the first private set, substituting the specific hash (hₖ) into said particular polynomial (fⱼ(hₖ, )) and reducing modulo the reduction integer associated with said particular polynomial (fⱼ), and
summing the further set of univariate polynomials,
wherein said generated digital signature comprises a fifth set of signature polynomials (232, S_{M,k}( )) comprising at least part of each signature polynomial generated by the signature key generator for the fourth set of hashes (hₖ).

15. An electronic signature verification method for verifying a digital signature (S_{M}( )) generated by an electronic signature generation method as in claim 14, the signature verification method having access to at least one commitment integer and the at least one corresponding univariate public polynomial generated by an electronic key generation method as in claim 13, the digital signature comprising at least one univariate signature polynomial (232, S_{M}( ); S_{M,k}( )),
determining a hash corresponding to a signature polynomial by applying a hash function to the digital data (hₖ=hₖ(M)),
verifying the signature including verifying a match between the at least one univariate signature polynomial (232, S_{M,k}( )) and the at least one univariate public polynomial, by for a specific univariate signature polynomial of the at least one univariate signature polynomial and a specific univariate public polynomial of the at least one univariate public polynomial,
substituting the hash corresponding to the specific signature polynomial in the specific public polynomial, thus obtaining a first substitution result
substituting the commitment integer corresponding to the specific public polynomial in the specific signature polynomial obtaining a second substitution result,
verifying that the first substitution result matches the second substitution result, wherein the signature verification device requires a match to verify the digital signature (S_{M}( )).

16. A computer program comprising computer program code means adapted to perform all the steps of claim 13 when the computer program is run on a computer.

17. A computer program as claimed in claim 16 embodied on a computer readable medium.
